(19) United States
(12) Patent Application Publication
(10) Pub. No.: US 2025/0322253 A1
(43) Pub. Date: Oct. 16, 2025

(54) ARTIFICIAL NEURAL NETWORK PROCESSING METHODS AND SYSTEMS

(71) Applicant: STMicroelectronics International N.V., Geneva (CH)

(72) Inventors: Francesco Rundo, Gravina di Catania (IT); Carmelo Pino, Catania (IT); Salvatore Coffa, Milano (IT); Giulia Castagnolo, Randazzo (CT) (IT)

(21) Appl. No.: 19/078,882

(22) Filed: Mar. 13, 2025

(30) Foreign Application Priority Data
Apr. 11, 2024 (IT) 102024000008095

(51) Int. Cl. G06N 3/092; G06N 3/0464

(52) U.S. Cl. CPC G06N 3/092; G06N 3/0464

(57) ABSTRACT

A method includes applying first artificial neural network (ANN) processing to at least one input dataset via a first ANN processing stage, producing a first set of output values as a result, applying second ANN processing to the at least one input dataset via a plurality of further ANN processing stages, producing a second set of output values as a result, computing a first loss value based on the first set of output values and on the second set of output values, computing a second loss value based on the second set of output values, computing a total loss based on the first loss value and on the second loss value, and adjusting values of sets of weight parameters in each set of processing layer parameters of each ANN processing stage in the plurality of further ANN processing stages based on the computed total loss.

### CROSS-REFERENCED TO RELATED APPLICATIONS

This application claims the benefit of Italian Patent Application No. 102024000008095, filed on Apr. 11, 2024, which application is hereby incorporated herein by reference.

### TECHNICAL FIELD

The description relates to an artificial neural network (ANN) processing method and system.

One or more embodiments relate to one or more processing devices, such as edge computing processing devices, e.g., configured to perform neural network processing operations.

### BACKGROUND

Complex artificial neural network processing models (currently denoted as “backbone” or “machine learning”) may involve computational and/or data storage resources exceeding the capabilities of edge processing devices (such as microcontrollers, for instance).

One of the issues in adapting large machine learning models and applications to edge computing is the reduced computational resources of the latter.

Existing approaches to solve the issue involve attempts at “distillating” (or compressing) the knowledge obtained from large models into smaller models whose computational use is reduced.

For instance, existing approaches are discussed in the following documents:
Hinton, G. E., Vinyals, O., & Dean, J. (2015): “Distilling the Knowledge in a Neural Network”, ArXiv, abs/1503.02531 discusses a way to compress the knowledge in an ensemble into a single model which is much easier to deploy by introducing a new type of ensemble composed of one or more full models and many specialist models which learn to distinguish fine-grained classes that the full models confuse;
Romero, A., Ballas, N., Kahou, S. E., Chassang, A., Gatta, C., & Bengio, Y. (2014): “FitNets: Hints for Thin Deep Nets”, CoRR, abs/1412.6550 discusses knowledge distillation to allow the training of a student node that is deeper and thinner than the teacher node, using the intermediate representations learned by the teacher as hints to improve the training process and final performance of the student node;
Yim, J., Joo, D., Bae, J., & Kim, J. (2017): “A Gift from Knowledge Distillation: Fast Optimization, Network Minimization and Transfer Learning”, 2017 IEEE Conference on Computer Vision and Pattern Recognition (CVPR), 7130-7138 discusses a novel technique for knowledge transfer, where knowledge from a pretrained deep neural network (DNN) is distilled and transferred to another DNN, which shows the student DNN that learns the distilled knowledge is optimized much faster than the original model and outperforms the original DNN.

Existing solutions present one or more of the following drawbacks: limited performance and automation, limited ability to adapt to different complex backbones, in particular for embedded solutions, or reduced distillation capability for large models.

### SUMMARY

An object of one or more embodiments is to contribute in overcoming the aforementioned drawbacks.

According to one or more embodiments, that object can be achieved via a method having the features set forth in the claims that follow.

A computer-implemented method may be exemplary of such a method.

One or more embodiments may relate to a corresponding processing device.

One or more embodiments may include a non-transitory computer program product loadable in the memory of at least one processing circuit (e.g., a computer) and including software code portions for executing the steps of the method when the product is run on at least one processing circuit. As used herein, reference to such a non-transitory computer program product is understood as being equivalent to reference to a non-transitory computer-readable medium containing instructions for controlling the processing system in order to co-ordinate implementation of the method according to one or more embodiments. Reference to “at least one computer” is intended to highlight the possibility for one or more embodiments to be implemented in modular and/or distributed form.

The claims are an integral part of the technical teaching provided herein with reference to the embodiments.

One or more embodiments facilitate deploying complex machine leaning methods on-board relatively simple devices such as micro-controllers.

One or more embodiments may be deployed on a set of microcontrollers arranged in a federated configuration.

### BRIEF DESCRIPTION OF THE DRAWINGS

One or more embodiments will now be described, by way of non-limiting example only, with reference to the annexed Figures, wherein:

FIG. 1 is a diagram exemplary of a deep neural network (DNN) topology;

FIG. 2 is a diagram exemplary of a first phase of a method as per the present disclosure;

FIG. 3 is a diagram exemplary of a second phase of a method as per the present disclosure;

FIG. 4 is a diagram exemplary of a signal processing pipeline as per the present disclosure;

FIG. 5 is a diagram exemplary of a portion of the signal processing pipeline of FIG. 4;

FIG. 6 is a diagram exemplary of a performance benchmark of one or more embodiments;

FIG. 7 is a diagram exemplary of an alternative signal processing pipeline as per the present disclosure;

FIG. 8 is a diagram exemplary of a portion of the diagram of FIGS. 5 and 7;

FIG. 9 comprises portions a), b) and c) representing diagrams exemplary of an alternative performance benchmark of one or more embodiments;

FIG. 10 is a diagram exemplary of a processing device as per the present disclosure; and

FIG. 11 is a diagram exemplary of a method of storing data in the device exemplified in FIG. 10.

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION OF ILLUSTRATIVE EMBODIMENTS

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in one or more points of the present description do not necessarily refer to one and the same embodiment.

Moreover, particular conformations, structures, or characteristics may be combined in any adequate way in one or more embodiments.

As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context indicates otherwise. In addition, throughout the specification, the meaning of “a,” “an,” and “the” include singular and plural references.

The references used herein are provided merely for convenience and hence do not define the extent of protection or the scope of the embodiments.

For the sake of simplicity, in the following detailed description a same reference symbol may be used to designate both a node/line in a circuit and a signal which may occur at that node or line.

The terms “processing device” may be used interchangeably in the following to refer to a “processing system” and is intended to denote a computing device/system apt to process data signals.

The term “dataset” may be used in the following to refer to a collection of signals of homogeneous or heterogeneous kind which may be stored in at least one data storage unit (or memory), such as a database accessible via an Internet connection.

A wide variety of technical domains (such as computer vision, speech recognition, and/or signal processing applications, for instance) may benefit from the use of artificial neural network (ANN) processing methods which may quickly apply hundreds, thousands, or even millions of concurrent processing operations to data signals. ANN methods, as discussed in this disclosure, may fall under the technological titles of learning/inference machines, machine learning, artificial intelligence, artificial neural networks, probabilistic inference engines, backbones, and the like.

Such learning/inference machines may have an underlying topology or architecture currently referred to as deep convolutional neural networks (DCNN).

A DCNN is a computer-based tool that applies data processing to large amounts of data and, by conflating proximally related features within the data, adaptively “learns” to perform pattern recognition on the data, thereby making broad predictions and refining the predictions based on reliable conclusions and new conflations.

For instance, a convolutional neural network (CNN) is a kind of DCNN.

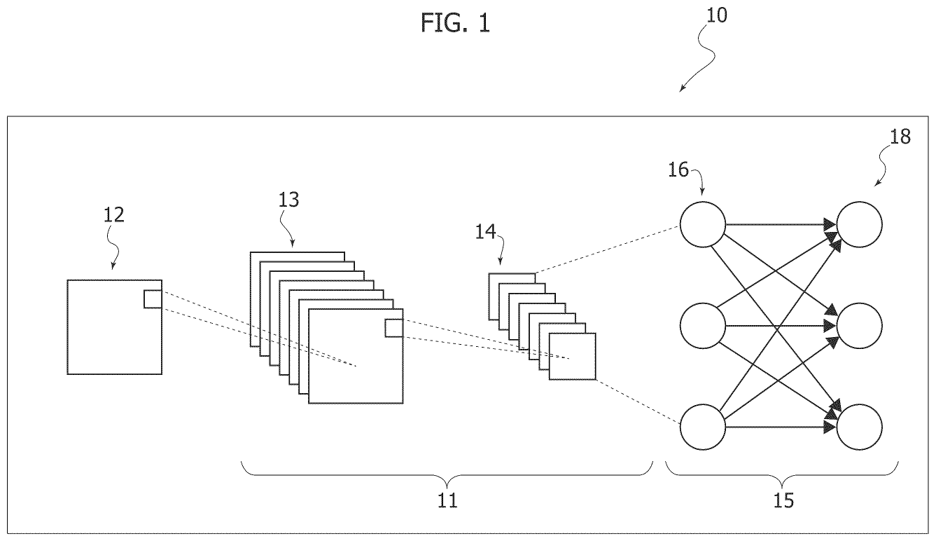

As exemplified in FIG. 1, a CNN pipeline 100 comprises a plurality of “layers” 12, 13, 14, 16, 18 and different types of data processing operations are made at each layer, such as feature extraction 11 and/or classification 15.

The most used types of layers are convolutional layers 13, fully connected or dense layers 16, and pooling layers 14 (max pooling, average pooling, etc.). Data exchanged between layers are called features.

As appreciable to those of skill in the art, each layer of the CNN 10 comprises a plurality of computing units currently denoted as perceptrons whose description is performed via a tuple of parameters. Such parameters may comprise, for instance:
a set of learnable parameters typically referred to as weights W, and
other parameters P such as activation function type, padding, stride, and so on, depending on the type of ANN processing layer.

The processing layers that are configured to apply ANN processing (e.g., convolution) to the input data provided at an input layer, thereby providing the processed data at an output layer, are currently referred to as “hidden layers”.

CNNs are particularly suitable for recognition tasks, such as recognition of numbers or objects in images, and may provide highly accurate results.

As appreciable to those of skill in the art, the computations performed by a CNN, or by other neural networks, often include repetitive computations over large amounts of data. Thereby, such “large” models may be executed onto computer devices having hardware acceleration sub-systems or comprising a wide network of computational and data storage resources such as those of a server.

The inventors have observed that, in order to perform similar operations to those available with large machine learning in environments with limited computational and memory resources, “large” ANN stages may teach to “smaller” ANN stages how they process the data, thereby facilitating an almost lossless compression of the machine learning model in terms of its performance.

For the sake of simplicity one or more embodiments are discussed herein mainly with reference to convolutional neural networks, CNNs, as deep neural network, DNN topology for the large or “teacher” ANN network, being otherwise understood that one or more embodiments may apply notionally to any complex ANN topology or pipeline.

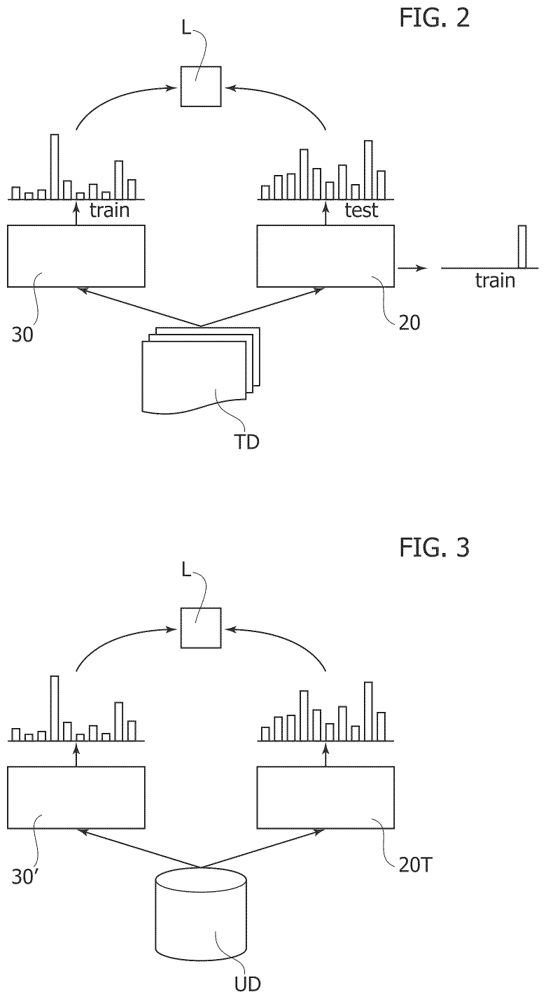

As exemplified in FIGS. 2 and 3, a method of reducing the computational complexity of large machine learning models comprises, in a first phase (also currently denoted as “training phase”):
providing a first “teacher” ANN module 20, such as a large CNN processing pipeline 10 having tens of layers of a wide variety of different types;
providing a second “student” ANN module 30, such as a smaller ANN with at least one order of magnitude of lower complexity;
providing a training dataset TD (e.g., a set of labeled images) comprising calibration data for which the ground-truth is known; and
training the teacher ANN module 20 to perform artificial neural network (ANN) processing (e.g., classify the images in the training dataset) and, at a same time, training the student ANN module 30 to perform the same operation of the teacher by using a composite loss function that takes into account the performance of both ANN processing pipelines 20, 30 in reducing the error with respect to the known classification.

The method exemplified in FIG. 2 facilitates obtaining a trained teacher ANN module 20T (whose weight values are set) and an at least partially trained student ANN module 30′ that has weight values based on the “observation” of the learning process of the teacher ANN module 20.

As exemplified in FIG. 3, the method of “knowledge distillation” for complexity reduction of ANN processing comprises, in a second phase (also currently denoted as “inference phase”):
providing a further dataset UD (also currently denoted as “unlabeled dataset”) for which a “ground-truth” is not (necessarily) available a priori;
applying ANN processing on the unlabeled dataset UD using both the trained teacher ANN module 20T and the (partially) trained student ANN module 30′; and
minimizing the loss function of the student by reducing the error in the output provided by the student ANN module 30′ with respect to that provided by the trained teacher ANN module 20T.

An operation of training exemplified in FIGS. 2 and 3 comprises minimizing at least one loss function LOSS based on a mean square error (MSE) between the logits z of the teacher 20 and of the student 30.

For instance, the loss function L that can be expressed as:

$${L}_{( {z}^{s} ( τ ) , {z}^{t} ( τ ) )} = {‖ {z}^{s ( τ )} - {z}^{t} ( τ ) ‖}_{2}^{2}$$

where
z^{s(t)} represents the logits of the teacher ANN module 20;
z^{T(t)} represents the logits of the student ANN module 30.

The logit function Z is mathematically defined as the logarithm of the odds of the probability p of a certain event occurring, which may be expressed as:

$$Z ( p ) = log ( p - ( 1 - p ) )$$

where p represents the probability of the event, and log denotes the natural logarithm.

As exemplified herein, the logit function Z serves as a link function to map probabilities (ranging between 0 and 1) to real numbers, which can then be used to express linear relationships.

For instance, the teacher ANN module comprises either a CNN processing stage or a transformer network processing stage.

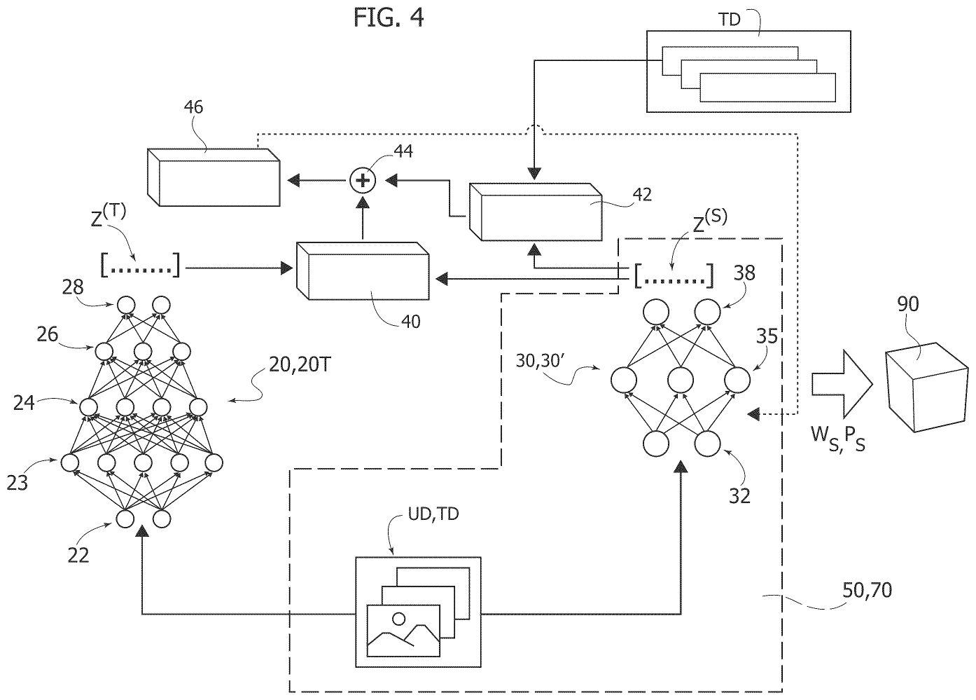

FIG. 4 is a diagram exemplary of a “knowledge distillation” pipeline as per the present disclosure which can be used for the first phase exemplified in FIGS. 2 and/or for the second phase exemplified in FIG. 3 of the method as per the present disclosure.

Such a pipeline is disclosed in Italian patent application number 102024000000861 not yet published at the filing date of the instant application.

As exemplified in FIG. 4, for instance:
the teacher ANN module 20T comprises a plurality of ANN processing layers 22, 23, 24, 26, 28 comprising an input layer 22, a convolutional layer 23, a pooling layer 24, a fully connected layer 26 and an output layer 28, and
the student ANN module 30 comprises an input layer 32, a generic hidden layer 35 and an output layer 38.

Therefore, the topology of the student ANN module 30, 30′ can be considered simpler (e.g., three times smaller in the example of FIG. 4) than the structure of the teacher ANN module 20, 20T.

Such a configuration of the teacher and student ANN modules 20, 20T, 30, 30′ is illustrated for the sake of simplicity, being otherwise understood that these configurations are purely exemplary and in no way limiting.

As exemplified in FIG. 4, the unlabeled dataset UD comprises a set of images. Again, the kind of training data illustrated in FIG. 4 purely for the sake of simplicity, being otherwise understood that notionally any kind of unlabeled data may be used to perform the knowledge distillation as exemplified herein.

In one or more embodiments known datasets may advantageously be used such as Cifar-100 and/or ImageNette publicly available datasets. The Canadian Institute For Advanced Research, CIFAR-100 dataset is a collection of images that are commonly used to train machine learning and computer vision algorithms. ImageNette is a subset created by Jeremy Howard of ten “easily” classified classes from the ImageNette dataset available online in the respective Github repository.

As exemplified in FIG. 4:
the images of the dataset TD, UD are processed by the networks of the teacher 20, 20T and the student 30, 30′;
performing a comparison of the output data of the teacher ANN module 20, 20T and of the student ANN module 30, 30′;
computing a distillation loss L_{D} based on the comparison (block 40 in FIG. 4);
based on the output data of the student ANN module 30, 30′, computing a classification loss L_{CE} for the student ANN module 30, 30′ (block 42 in FIG. 4);
computing a total loss L based on the distillation loss L_{D} and the classification loss L_{CE} (block 44 in FIG. 4); and
back propagating the computed total loss value L to the student ANN module 30, 30′ (preferably also to the teacher ANN module 20) and adjusting the parameters (such as weights Ws of the layers and/or other parameters Ps) of the student ANN module 30, 30′ until reaching a relative minimum for the total loss value L.

As exemplified in FIG. 4, once the loss function is minimized, the student ANN module parameters (such as weighting values Ws or other parameters Ps) can be provided to the edge device 90 for storage thereof and for their retrieval during ANN processing on the platform 90.

As exemplified herein, a “teacher” network 20, 20T, pre-trained on large dataset, is used as a guidance to develop a compressed network 30, 30′ onto which the operational functions of the teacher ANN module 20, 20′ are transferred without replicating the same computational complexity.

The compressed model 30, 30′ has a reduced number of ANN parameters and/or a simpler topology compared with the “teacher”, thereby resulting compatible with edge devices equipped with limited processing capabilities. For instance, STM32 cube devices may be equipped with the compressed model 30, 30′ in order to perform compressed ANN processing.

One or more embodiments use a total loss function L comprising a weighed sum of a first loss function L_{CE} of the student 30, 30′ and a distillation loss function L_{D} based on the comparison of the results of the student 30, 30′ with respect to the teacher 20, 20T. For instance, the total loss L may be expressed as:

$$L = ( 1 - α ) \cdot {ℒ}_{CE} + ( α + β ) \cdot {ℒ}_{D}$$

where
α is a positive reinforcement parameter having values in the range [0, 1], for instance configured to promote those neurons that distillate the knowledge of the teacher in a correct manner, and
β is a set of negative reinforcement parameters each having values in the range [0,1], for instance configured to demote the neurons that classify objects belonging to classes different from those assigned to them per each ANN processing stage in the set of student ANN processing stages 301, 302, . . . , 30N as discussed in the following.

For instance, a Kullback-Leibler divergence or Mean Square Error can be used as distillation loss L_{D}.

As exemplified in FIG. 4, a method as per the present disclosure comprises:
providing a first artificial neural network (ANN) processing stage 20, 20T comprising a first set of ANN processing layers 22, 23, 24, 26, 28, and
providing a second ANN processing stage 30, 30′ comprising a second set of ANN processing layers 32, 35, 38 having a set of processing layer parameters Ws, Ps comprising at least one set of ANN processing weights Wₛ.

As exemplified herein, the number of processing layers in the first set of ANN processing layers is greater than the number of processing layers in the second set of ANN processing layers.

In one or more embodiments, the topology of the student ANN module 30, 30′ may be designed considering the processing capabilities of edge devices (e.g., microcontroller devices) in a heuristic manner, for instance in order to take find a tradeoff between application and computing performance.

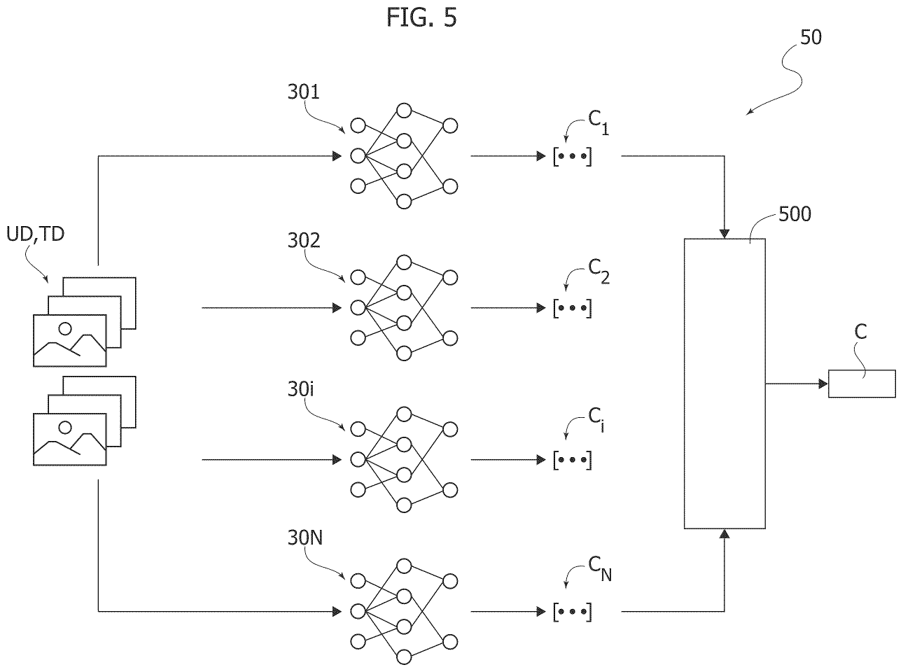

As exemplified in FIG. 4, in an exemplary scenario in which the teacher model is considerably larger than the computational resources of the edge device 90, it may be possible to design the student network 30, 30′ according to at least one architecture, as discussed in the following with reference to FIGS. 5 to 11.

FIG. 5 is a diagram exemplary of a “full ensembling” method to share the “learning” workload of the student network 30, 30′ among a set of student networks.

In a method as exemplified in FIG. 5, the second ANN processing stage 30, 30′ comprises a second set of ANN processing stages 301, 302, 30i, 30M, wherein each stage (e.g., 30i) comprises a set of processing layer parameters (e.g., Wsᵢ, Psᵢ) comprising at least one set of ANN processing weights (e.g., Wₛᵢ).

In the scenario exemplified in FIG. 5, the method comprises:
training a second set of (e.g., parallel) ANN stages 301, 302, 30i, 30N to at least one input dataset TD via the ANN processing stages in the second set of ANN processing stages 301, 302, 30i, 30N to classify a subset of the classification labels present in the entire input dataset;
applying the trained second set of ANN stages 301, 302, 301, 30N to the at least one input dataset UD via the ANN processing stages in the second set of ANN processing stages 301, 302, 30i, 30N, producing a set of probability/confidence scores C₁(s), C₂(s), Cᵢ(s), C_{N}(s) as discussed in the following; and
applying classification processing 500 to the set of output scores C₁(s), C₂(s), Cᵢ(s), C_{N}(s), e.g., computing a softmax function thereof, providing a global score as a result.

The approach exemplified in FIG. 5 can be particularly suited for those scenarios in which the training dataset TD comprises a wide variety of possible classification labels.

The inventors have noted that each of the parallel ANN processing stages in the set of processing stages 301, 302, 30i, 30M provides a probability score higher in response to classifying data belonging to the subset of classification labels on which it has been trained.

The approach exemplified in FIG. 5 exploits the combination of the predictions of an ensemble of models 301, 302, 30i, 30N into one final prediction z(s). In this strategy, each model assigns the respective probability (or confidence) score to each possible classification label in the output.

For instance, the probability or confidence score can be expressed as:

$${C}_{j} = \frac{{\sum }_{k = 0}^{k = N} {p}_{jk}}{N} , with j = [ 0 , … , M ]$$

where
M is the (e.g., dynamic) number of classification labels;
N is the (e.g., dynamic) number of ANN stages in the set of ANN processing stages 301, 302, 301, 30N;
For instance, the global output score C can be expressed as:

$$C = arg max ( {C}_{0} , {C}_{1} , … {C}_{m} )$$

As exemplified in FIGS. 4 and 5, during the inference phase the second loss value L_{CE} is based on the global probability score C and computing 44 a total loss L is based on the first loss value L_{D} and on the second loss value L_{CE}.

For instance, a first value (e.g., β₁ located at the initial position of an array of values) in the set of negative reinforcement parameters β used to weight the contribution of the first loss Ld to the total loss L can be determined to reduce the contribution of the first lost Ld whenever an ANN processing stage (e.g., 301) in the set of ANN processing stages 301, 302, 301, 30N classifies an object (e.g., book) that does not belong to the class of objects (e.g., animals) that has a classification label belonging to the M classification labels (e.g., M=5 set by the user or extracted via automated clustering as discussed in the following) assigned to that ANN processing stage (e.g., 301). In case there is no “misbehavior” among the ANN processing stages 301, 302, . . . , 30N the negative reinforcement parameter has not effect on the total loss L, e.g., β equal to a null array.

For instance, adjusting 46 the values of the processing layer parameters in the set of processing layer parameters Wsi, Psi of each ANN processing stage 301, 302, 301, 30M in the second ANN processing stage 30, 30′ is based on the total loss value L.

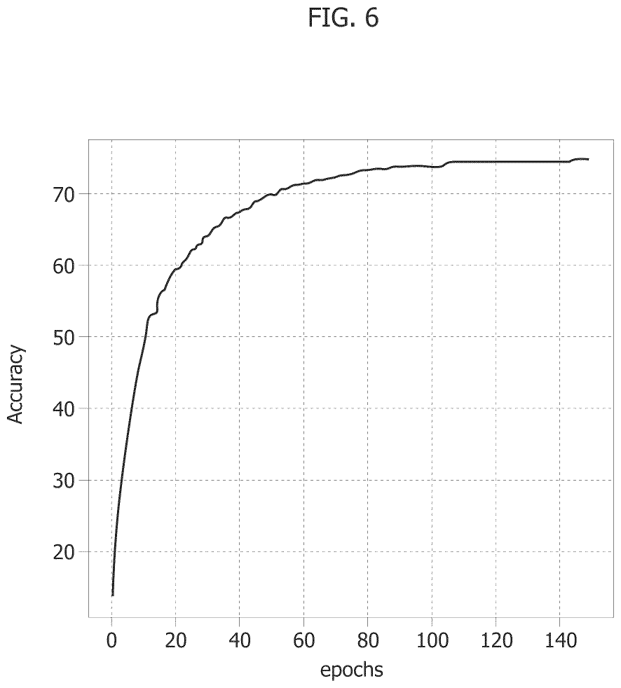

FIG. 6 illustrates the performance of a student ANN module 50 comprising a number N=5 of ANN stages 301, 302, 30i, 30M each dedicated to assigning a number M=20 of classification labels to each processing line.

As exemplified in FIG. 6, both the student VGG11 and the teacher ViT-16 receive as input data TD, UD the Cifar-100 dataset comprising a total of M*N=100 classes.

FIG. 6 is a plot of the evolution over time (abscissa scale, in epoch units) of the classification accuracy (ordinate scale, in percentage units) of the student ANN module VGG11 showing the possibility to reach an accuracy about 74.52%. This result provides an increase of accuracy with respect to the performance of a single-ANN-staged student architecture.

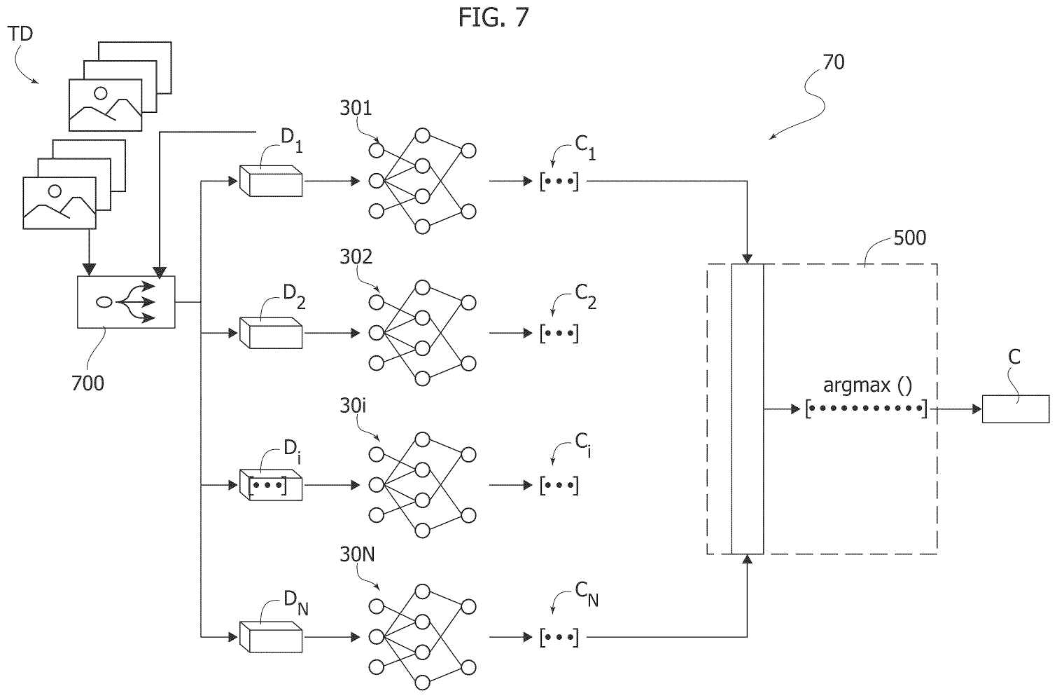

FIG. 7 is a diagram exemplary of an alternative embodiment of the method of designing a student architecture exemplified in FIGS. 4 and 5.

As exemplified in FIG. 7, training the second set of ANN networks 301, 302, 30i, 30N further comprises slitting 700 to the training dataset TD in a plurality of training datasets D1, D2, Di, DN each comprising data related to a subset of classification labels.

For instance:
a first training dataset D1 comprises data belonging to classification labels [1,p];
a second training dataset D2 comprises data belonging to classification labels [p+1,k];
an i-th training dataset Di comprises data belonging to classification labels [k+1,i]; and
an N-th training dataset DN comprises data belonging to classification labels [i+1; q] where q is the maximum number of classification labels of the original training dataset TD (e.g., q=100 for CIFAR-100 training dataset).

The reference numbers used in FIG. 7 and in FIG. 5 indicate that, except for the data splitting, the method of processing of the data is the same in both exemplified cases.

The alternative approach exemplified in FIG. 7 differs from that of FIG. 5 in that the probability scores output by the student ANN stages in the set of student ANN stages 301, 302, 30i, 30N are more “polarized” since the probability score given by a ANN stage (e.g., 302) for data belonging to a class on which it has not been trained (e.g., class p) is close to zero while the probability score of the ANN ann (e.g., 301) trained on the (e.g., first D1) training dataset to which the actual data belongs (e.g., class p) is close to unity.

For instance, this facilitates assigning initial values to the set of negative reinforcement parameters β.

It is noted that the alternative embodiment exemplified in FIG. 7 may be particularly suited in case in which the training dataset TD is a balanced dataset, e.g., comprising a same number of data samples per each classification label.

In the alternative scenario exemplified in FIG. 7 it may be possible to apply an automatic clustering procedure to perform splitting 700 of the training dataset TD.

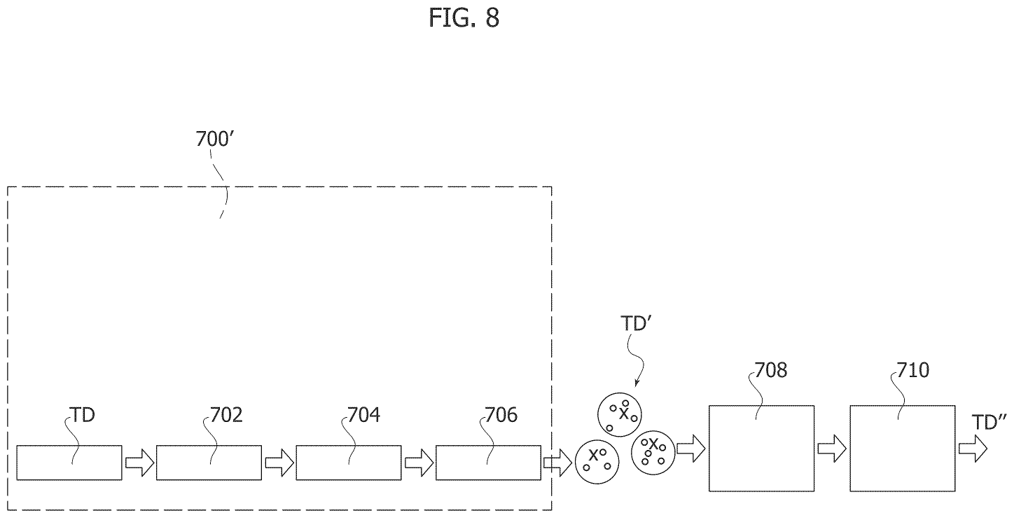

As exemplified in FIG. 8, the automatic clustering method 700′ comprises:
block 702: receiving the training dataset TD and applying data dimensionality reduction processing thereto, providing a reduced dataset as a result;
block 704: applying clustering to the reduced training dataset provided as a result of applying data dimensionality reduction to the training dataset TD;
block 706: obtaining a set of clusters as a result of applying clustering, providing an automatically clustered training dataset TD′;
block 708: applying K-means clustering to the automatically clustered training dataset TD′; and
block 710: detecting cosine similarity among the K-mean clusters of the automatically clustered training dataset TD′ and providing a further automatically clustered training dataset TD″.

In one or more embodiments, the operation of performing data dimensionality reduction exemplified in block 702 may exploit a technique currently referred to as UMAP and discussed in document McInnes et al. “UMAP: Uniform Manifold Approximation and Projection for Dimension Reduction”, ArXiv e-prints 1802.03426, 2018.

In one or more embodiments, the operation of clustering exemplified in block 704 can exploit HDBSCAN discussed in document.

One or more embodiments comprising automated semantic splitting based on close features as discussed in the foregoing may improve the distillation process with respect to a user-defined splitting/dividing of the classes per ANN processing stage based on the distribution of samples in the original training dataset.

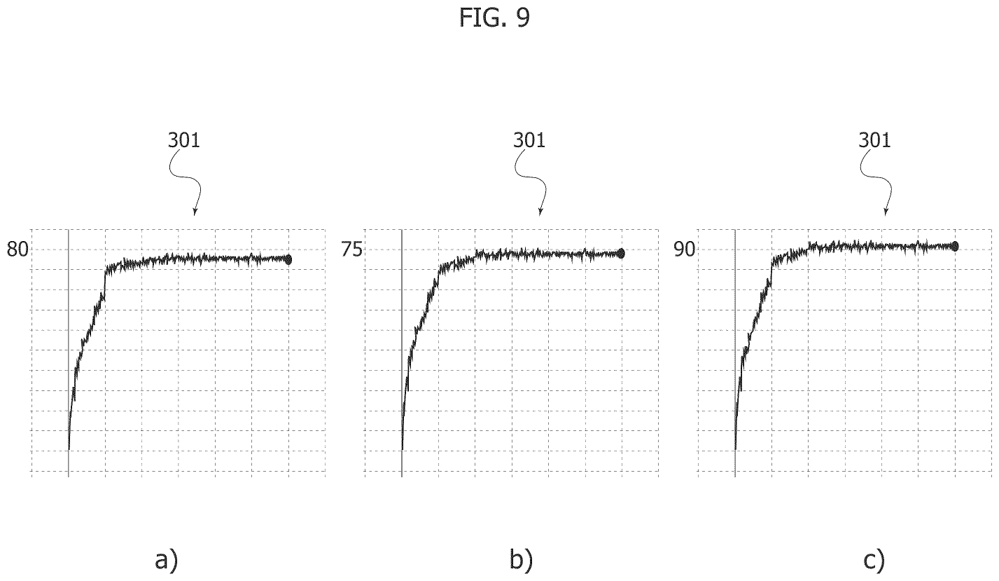

FIG. 9 comprising portions a) to c) is illustrative of an exemplary scenario in which the student 30 comprises at least three parallel ANN stages 301, 302, 303.

For instance:
portion a) of FIG. 9 is a plot of the evolution over time (abscissa scale, in epoch units) of the classification accuracy (ordinate scale, in percentage units) of a first ANN stage 301 trained over the first training dataset D1 of a student ANN module VGG11;
portion b) of FIG. 9 is a plot of the evolution over time (abscissa scale, in epoch units) of the classification accuracy (ordinate scale, in percentage units) of a second ANN stage 302 trained over the second dataset D2 of the student ANN module VGG11; and
portion c) of FIG. 9 is a plot of the evolution over time (abscissa scale, in epoch units) of the classification accuracy (ordinate scale, in percentage units) of a third ANN stage 303 trained over the third dataset D3 of the student ANN module VGG11.

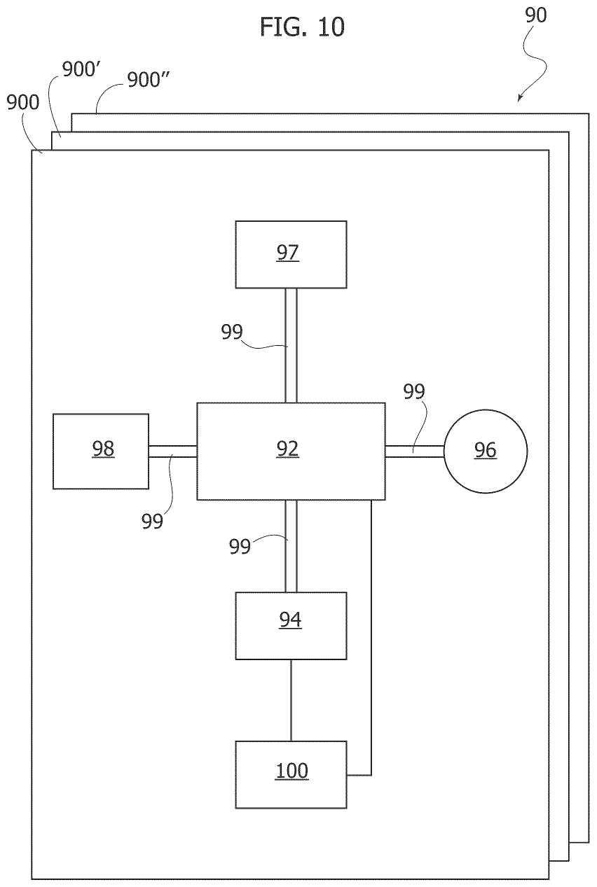

FIG. 10 is a block diagram of a system 90 suitable to execute instructions of the student ANN module 30, 30′.

As exemplified in FIG. 10, the system 90 comprises a plurality of processing devices 900, 900′, 900″ each comprising:
one or more processing cores or circuits 92 configured to control overall operation of the system 90, execution of application programs by the device 900, 900′, 900″ (e.g., programs which classify images using CNNs), etc.;
one or more non-transitory memories 94, such as one or more volatile and/or non-volatile memories which may store, for example, all or part of instructions and data related to control of the device 900, 900′, 900″, applications and operations performed by the device 900, 900′, 900″ etc.; for instance, weight values Ws and ANN parameters Ps for each of the student ANN processing stages 301, 302, 30i, 30N of the student ANN module 30, 30′ may be stored in each memory 94 of each device 900, 900′, 900″ of the system 90;
one or more sensors 96 (e.g., image sensors, audio sensors, accelerometers, pressure sensors, temperature sensors, etc.);
one or more interfaces 97 (e.g., wireless communication interfaces, wired communication interfaces, etc.); and
other circuits 98, which may include antennas, power supplies, one or more built-in self-test (briefly, BIST) circuits, etc., and a main bus system 99.

For instance, the processing cores 92 may comprise one or more processors, a state machine, a microprocessor, a programmable logic circuit, discrete circuitry, logic gates, registers, etc., and/or various combinations thereof.

For instance, one or more of the memories 94 may include a memory array, which, in operation, may be shared by one or more processes executed by the system 90.

For instance, the main bus system 99 may include one or more data, address, power and/or control buses coupled to the various components of the system 90.

As exemplified in FIG. 10, preferably the system 90 also comprises one or more hardware accelerators 100 which, in operation, accelerate the performance of one or more operations associated with implementing a CNN. The hardware accelerator 100 as illustrated includes one or more convolutional accelerators to facilitate efficient performance of convolutions associated with convolutional layers of a CNN, for instance.

As exemplified herein, a non-transitory computer program product comprises instructions which, when the program is executed by a computer, cause the computer to carry out the method exemplified in FIGS. 4, 5 and 7.

As exemplified herein, a non-transitory computer-readable medium has stored thereon the values of the set of processing layer parameters Ws, Ps obtained using the method exemplified in FIG. 4.

As exemplified in FIG. 10, a non-transitory computer-readable medium 94 of each of the devices 900, 900′, 900″ of the system 90 has stored thereon the values of the set of processing layer parameters (e.g., Wsi, Psi) for each of the student ANN processing stages in the set of student ANN processing stages 301, 302, 30i, 30N trained using the method exemplified in FIGS. 5 and/or 7.

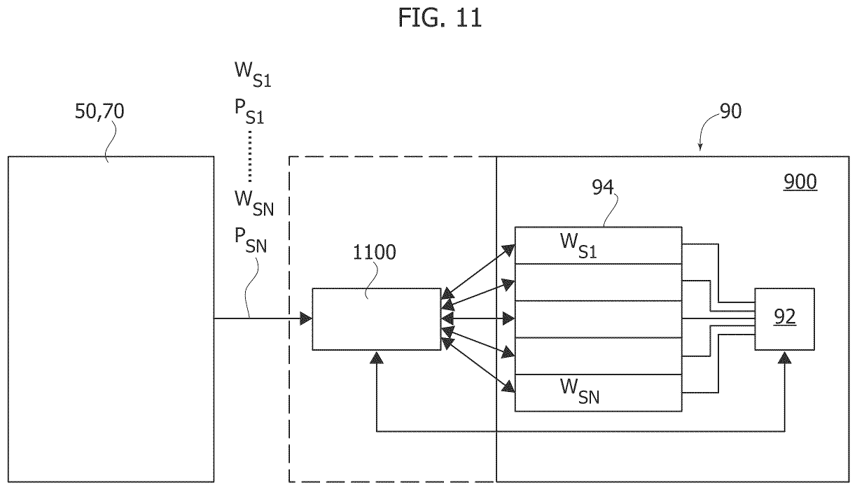

In an alternative scenario as exemplified in FIG. 11 it may be possible to load all the ANN parameters (e.g., weights Ws) of each student ANN stage in the set of student ANN stages 301, 302, 30i, 30N exemplified in FIGS. 5 and/or 7 in consecutive memory blocks of a memory unit 94 of a single processing device 900 in the system 90 by using a sequential loader stage 1100.

For instance, the sequential loader 1100 may be further coupled to the core(s) 92 of the device 900 in order to subsequently execute instructions to run the trained student models 301, 302, 30i, 30N to use the student ANN model 30′ during inference (that is, with input data different from the training one).

For instance, the use of the method of FIG. 11 facilitates reducing a number of processing devices 900, 900′, 900″ in the system 90.

As exemplified in FIG. 11, a method of operating a processing device 90 configured to perform artificial neural network (ANN) processing as a function of a set of processing layer parameters Ws1, Ps1, . . . , WsN, PsN, comprises:
sequentially accessing 94 values of the set of processing layer parameters Ws, Ps, preferably weighting parameters Wsi, obtained using the method exemplified in FIGS. 4 and 5 or 7, and
performing artificial neural network (ANN) processing 30, 30′ as a function of the values of the set of processing layer parameters.

As exemplified herein, a non-transitory computer program product comprises instructions which, when the program is executed by a processing device 90, cause the processing device to carry out ANN processing according to a method as per the present disclosure.

As exemplified herein, a non-transitory computer-readable medium comprises instructions which, when executed by a processing device 90, cause the processing device to carry out ANN processing according to the method as exemplified herein.

As exemplified in FIG. 9, a processing device 90 comprises non-transitory memory circuitry 94 having stored therein:
adjusted values of the set of processing layer parameters Ws1, Ps, . . . , Wsi, Psi, . . . , WSN, PSN obtained using the method exemplified in FIGS. 4 and 5 or 7, and
instructions which, when executed in the processing device, cause the processing device to:
   access 94 the adjusted values of the set of processing layer parameters, and
   perform ANN processing as a function of the adjusted values of the set of processing layer parameters Ws1, Ps1, . . . , Wsi, Psi, . . . , Ws_{N}, Ps_{N}.

A method as exemplified in FIGS. 1 to 8 (such as a computer-implemented method, for instance) comprises:
providing a first artificial neural network (ANN) processing stage 20, 20T comprising a first set of ANN processing layers 22, 23, 24, 26, 28, and
providing a plurality of further ANN processing stages.

For instance, each further ANN processing stage in the plurality of further ANN processing stages comprises a respective set of ANN processing layers having a respective set of ANN processing layer parameters comprising weight parameters.

As exemplified in FIGS. 1 to 7, the method further comprises:
applying first ANN processing to at least one input dataset via the first ANN processing stage, producing a first set of output values as a result;
applying second ANN processing to the at least one input dataset via the plurality of further ANN processing stages, producing a second set of output values as a result;
computing a first loss value L_{D} based on the first set of output values and the second set of output values;
computing a second loss value L_{CE} based on the second set of output values;
computing a total loss L based on the first loss value L_{D} and on the second loss value L_{CE}; and
adjusting the values of the sets of weight parameters in each set of processing layer parameters of each ANN processing stage in the plurality of further ANN processing stages based on the computed total loss.

As exemplified in FIGS. 1 to 8, the number of processing layers in the first set of ANN processing layers is (e.g., three times) greater than the sum of all the processing layers of all the ANN processing stages in the plurality of second ANN processing stages.

As exemplified in FIGS. 7 and 8, during a training phase of the plurality of second ANN processing stages, the method comprises dividing the at least one input dataset into a plurality of input dataset portions via a signal pre-processing stage.

For instance:
each input dataset portion in the plurality of input dataset portions comprises a different portion of the at least one input dataset;
the signal pre-processing stage is configured to apply dataset distribution processing, distributing the at least one input dataset into a number of dataset portions equal to the number of further processing stages in the plurality of further ANN processing stages; and
the method further comprises applying ANN processing to each of the input dataset portions in the plurality of input dataset portions of the at least one input dataset via the respective ANN processing stage in the plurality of further ANN processing stages, producing a second set of output values as a result.

As exemplified in FIGS. 7 and 8, applying the class distribution processing comprises distributing classes of data of the at least one dataset using at least one of:
a uniform distribution comprising distributing a same number of classes of data in each dataset portion irrespective of whether the amount of data in each class is the same or different, as exemplified in FIG. 7, or
clustering distribution processing comprising weighting the amount of data in each class and varying accordingly the number of classes of data in each dataset portion, as exemplified in FIGS. 7 and 8.

As exemplified herein, applying normalization processing (e.g., applying a softmax function) to the second set of output values provided by the ANN processing stages in the plurality of further ANN processing stages, providing a set of normalized scores as a result. For instance, the method further comprises computing 42 the second loss value L_{CE} based on the set of normalized scores.

As exemplified herein, computing 44 the total loss L comprises a (e.g., linear) combination of the first loss value L_{D} and of the second loss value L_{CE}.

For instance, the total loss L is expressed as:

$$L = ( 1 - α ) \cdot {L}_{CE} + ( α + β ) \cdot {L}_{D}$$

where
α is a positive reinforcement parameter having a value in a range 0 to 1, preferably in a range of values 0.5 to 0.9;
β is a set of negative reinforcement parameters having values in a range 0 to 1;
L_{CE} is the first loss value, and
L_{D} is the second loss value.

As exemplified in FIGS. 1 to 4, providing the first artificial neural network (ANN) processing stage comprises providing a convolutional neural network, CNN processing stage or a transformer network processing stage.

A non-transitory computer-readable medium as exemplified in FIGS. 10 and 11, comprising instructions which, when executed by a computer, cause the computer to carry out the method exemplified in FIGS. 1 to 8.

Exemplified in FIGS. 10 and 11 is a method of operating a processing system 90 comprising a set of processing devices configured to perform artificial neural network (ANN) processing on at least one input dataset UD as a function of a set of processing layer parameters comprising weight values stored on a set of non-transitory data storage portions 94 of the set of processing devices. For instance, the method comprises, for each processing device in the set of processing devices: accessing the data storage portion and retrieving therefrom weight values obtained using the method exemplified in FIGS. 1 to 8, and performing artificial neural network (ANN) processing on the at least one input dataset via the processing device based on the weight values in the set of processing layer parameters.

As exemplified in FIG. 11, a non-transitory computer-readable medium has stored therein, at adjacent memory addresses, values of weight parameters in the set of processing layer parameters of each ANN processing stage in the set of further ANN processing stages, wherein the values of the weight parameters are obtained using the method exemplified in FIGS. 1 to 8.

For instance, a processing device 900 (e.g., a microcontroller) as exemplified in FIGS. 10 and 11, comprises non-transitory memory circuitry 94 having stored thereon:
at adjacent memory addresses, values of weight parameters in the set of processing layer parameters of each ANN processing stage in the set of further ANN processing stages, wherein the values of the weight parameters are obtained using the method exemplified in FIGS. 1 to 8, and
instructions which, when executed in the processing device, cause the processing device to sequentially access the adjusted values of the weight parameters in the set of processing layer parameters, and to sequentially perform ANN processing as a function of the adjusted values of the weight parameters in the set of processing layer parameters.

For instance, the processing device comprises a microcontroller device.

It will be otherwise understood that the various individual implementing options exemplified throughout the figures accompanying this description are not necessarily intended to be adopted in the same combinations exemplified in the figures. One or more embodiments may thus adopt these (otherwise non-mandatory) options individually and/or in different combinations with respect to the combination exemplified in the accompanying figures.

Without prejudice to the underlying principles, the details and embodiments may vary, even significantly, with respect to what has been described by way of example only, without departing from the extent of protection. The extent of protection is defined by the annexed claims.

What is claimed is:

1. A method, comprising:
providing a first artificial neural network (ANN) processing stage comprising a first set of ANN processing layers;
providing a plurality of further ANN processing stages, each further ANN processing stage in the plurality of further ANN processing stages comprising a respective set of ANN processing layers having a respective set of ANN processing layer parameters comprising sets of weight parameters;
applying first ANN processing to at least one input dataset via the first ANN processing stage to produce a first set of output values;
applying second ANN processing to the at least one input dataset via the plurality of further ANN processing stages to produce a second set of output values;
computing a first loss value based on the first set of output values and the second set of output values;
computing a second loss value based on the second set of output values;
computing a total loss based on the first loss value and on the second loss value; and
adjusting values of the sets of weight parameters in each set of processing layer parameters of each further ANN processing stage in the plurality of further ANN processing stages based on the computed total loss.

2. The method of claim 1, wherein a number of ANN processing layers in the first set of ANN processing layers is greater than a sum of all ANN processing layers of all the further ANN processing stages in the plurality of further ANN processing stages.

3. The method of claim 2, wherein the number of ANN processing layers in the first set of ANN processing layers is three times greater than the sum of all ANN processing layers of all the further ANN processing stages in the plurality of further ANN processing stages.

4. The method of claim 1, comprising:
during a training phase of the plurality of further ANN processing stages, dividing the at least one input dataset into a plurality of input dataset portions via a signal pre-processing stage, each input dataset portion in the plurality of input dataset portions comprising a different portion of the at least one input dataset, the signal pre-processing stage being configured to apply dataset distribution processing, and distributing the at least one input dataset into a number of dataset portions equal to a number of further processing stages in the plurality of further ANN processing stages; and
applying the second ANN processing to each of the input dataset portions in the plurality of input dataset portions of the at least one input dataset via a respective ANN processing stage in the plurality of further ANN processing stages to produce the second set of output values.

5. The method of claim 4, wherein the dataset distribution processing comprises distributing classes of data of the at least one input dataset using at least one of:
uniform distribution comprising distributing a same number of classes of data in each dataset portion irrespective of whether an amount of data in each class is the same or different; or
clustering distribution processing comprising weighting the amount of data in each class and varying accordingly a number of classes of data in each dataset portion.

6. The method of claim 1, comprising:
applying normalization processing to the second set of output values provided by the further ANN processing stages in the plurality of further ANN processing stages to provide a set of normalized scores; and
based on the set of normalized scores, computing the second loss value.

7. The method of claim 1, wherein applying normalization processing comprises applying a softmax function to the second set of output values.

8. The method of claim 1, wherein computing the total loss comprises computing a linear combination of the first loss value and of the second loss value.

9. The method of claim 8, wherein the total loss is expressed as:
$$L = ( 1 - α ) \cdot {L}_{CE} + ( α + β ) \cdot {L}_{D}$$
where
α is a positive reinforcement parameter having a value in a first range of 0 to 1;
β is a set of negative reinforcement parameters having values in a second range of 0 to 1;
L_{CE} is the first loss value; and
L_{D} is the second loss value.

10. The method of claim 9, where the first range is 0.5 to 0.9.

11. The method of claim 1, wherein providing each ANN processing stage comprises providing:
a convolutional neural network, CNN processing stage; or
a transformer network processing stage.

12. The method of claim 1, further comprising:
storing the sets of processing layer parameters comprising the values of the weight parameters on a respective set of non-transitory data storage portions of a set of processing devices; and
for each processing device in the set of processing devices:
accessing the respective non-transitory data storage portion and retrieving therefrom the respective values of the weight parameters; and
performing respective ANN processing on the at least one input dataset based on the respective values of the weight parameters in the respective set of processing layer parameters.

13. A non-transitory computer program product comprising instructions which, when the program is executed by a computer, cause the computer to:
provide a first artificial neural network (ANN) processing stage comprising a first set of ANN processing layers;
provide a plurality of further ANN processing stages, each further ANN processing stage in the plurality of further ANN processing stages comprising a respective set of ANN processing layers having a respective set of ANN processing layer parameters comprising sets of weight parameters;
apply first ANN processing to at least one input dataset via the first ANN processing stage to produce a first set of output values;
apply second ANN processing to the at least one input dataset via the plurality of further ANN processing stages to produce a second set of output values;
compute a first loss value based on the first set of output values and the second set of output values;
compute a second loss value based on the second set of output values;
compute a total loss based on the first loss value and on the second loss value; and
adjust values of the sets of weight parameters in each set of processing layer parameters of each further ANN processing stage in the plurality of further ANN processing stages based on the computed total loss.

14. A processing device comprising:
a processor; and
non-transitory memory circuitry communicatively coupled to the processor, and having stored therein:
at adjacent memory addresses, values of weight parameters in a set of processing layer parameters of each ANN processing stage in a set of further ANN processing stages; and
instructions which, when executed by the processor, cause the processor to:
provide a first artificial neural network (ANN) processing stage comprising a first set of ANN processing layers;
provide a plurality of further ANN processing stages, each further ANN processing stage in the plurality of further ANN processing stages comprising a respective set of ANN processing layers having a respective set of ANN processing layer parameters comprising sets of weight parameters;
apply first ANN processing to at least one input dataset via the first ANN processing stage to produce a first set of output values;
apply second ANN processing to the at least one input dataset via the plurality of further ANN processing stages to produce a second set of output values;
compute a first loss value based on the first set of output values and the second set of output values;
compute a second loss value based on the second set of output values;
compute a total loss based on the first loss value and on the second loss value;
adjust values of the sets of weight parameters in each set of processing layer parameters of each further ANN processing stage in the plurality of further ANN processing stages based on the computed total loss;
sequentially access the adjusted values of the weight parameters in the set of processing layer parameters; and
sequentially perform ANN processing as a function of the adjusted values of the weight parameters in the set of processing layer parameters.

15. The processing device of claim 14, wherein the processing device is a microcontroller.

16. The processing device of claim 14, wherein a number of ANN processing layers in the first set of ANN processing layers is greater than a sum of all ANN processing layers of all the further ANN processing stages in the plurality of further ANN processing stages.

17. The processing device of claim 14, wherein the non-transitory memory circuitry comprises further instructions which, when executed by the processor, cause the processor to:
during a training phase of the plurality of further ANN processing stages, divide the at least one input dataset into a plurality of input dataset portions via a signal pre-processing stage, each input dataset portion in the plurality of input dataset portions comprising a different portion of the at least one input dataset, the signal pre-processing stage being configured to apply dataset distribution processing, and distribute the at least one input dataset into a number of dataset portions equal to a number of further processing stages in the plurality of further ANN processing stages; and
apply the second ANN processing to each of the input dataset portions in the plurality of input dataset portions of the at least one input dataset via a respective ANN processing stage in the plurality of further ANN processing stages to produce the second set of output values.

18. The processing device of claim 14, wherein the non-transitory memory circuitry comprises further instructions which, when executed by the processor, cause the processor to:
applying normalization processing to the second set of output values provided by the further ANN processing stages in the plurality of further ANN processing stages to provide a set of normalized scores; and
based on the set of normalized scores, computing the second loss value.

19. The processing device of claim 14, wherein the instructions to apply normalization processing comprise instructions to apply a softmax function to the second set of output values.

20. The processing device of claim 14, wherein the instructions to compute the total loss comprise instructions to compute a linear combination of the first loss value and of the second loss value.
